(19) United States
(12) Patent Application Publication
(10) Pub. No.: US 2005/0188732 A1
(43) Pub. Date: Sep. 1, 2005

(54) Entry protection system and apparatus

(76) Inventor: John A. Kane, Amboy, WA (US)

Correspondence Address: KURT M RYLANDER, 1014 FRANKLIN STREET, SUITE 206, VANCOUVER, WA, 98660, US

(21) Appl. No.: 11/067,531

(22) Filed: Feb. 25, 2005

Related U.S. Application Data
(60) Provisional application No. 60/548,320, filed on Feb. 27, 2004.

(51) Int. Cl. E05B 15/16; E05B 17/14

(52) U.S. Cl. 70/417; 70/455

(57) ABSTRACT

A handle protection security device includes a base plate having a handle hole, a tubular handle cover attached to said base plate and over said handle hole, and wherein said tubular handle cover is provided with a key hole, and a rim attached to said base plate. A security protection kit includes a handle protection security device, a strike plate, and a security handle, wherein said security handle is opened by fitting a key in said handle and turning said key.

### CROSS-REFERENCE TO RELATED APPLICATION

The present application claims the benefit of and priority to prior co-pending U.S. Provisional Patent Application Ser. No. 60/548,320 filed on Feb. 27, 2004.

### FIELD OF THE INVENTION

The present invention relates to door security systems. More particularly, the present invention relates to door lock protection apparatuses.

### BACKGROUND

Residential and commercial building security is an important concern. For example, owners of buildings containing coin-operated machinery such as washers, dryers, video game consoles, etc. are often victims of robbery and vandalism directed at the coin-operated machinery. Such unwanted entries are often made through doors. Doors with standard or high-grade locksets are susceptible to multiple types of unwanted bypass such as: breaking the knob mechanism with pliers or wrench; forcing defeat of lockset by prying or wedging, jimmying door in line with latch; forcing door open by application of impact force to outside of door. Thus, there is a need for added protection on doors and doorframes. Existing systems and methods fail to adequately address or solve this problem. Numerous locks and methods of rendering doors resistant to forcible entry and illegal entry have been made over time.

The commercial lockset style handle, such as that from the Schlage Lock Company, together with a set of three properly installed spring-closure hinges, prevent entry into a protected premises by anyone other than someone having a key which operates the lockset. The outside knob does not turn, and a key is required to withdraw the entry latch from the striker plate to allow the door to open. The spring-loaded hinges assure that the door will close and re-latch as soon as the entering or leaving person lets go of the door. However, a lockset style handle can be defeated by any of several forcible methods. Moreover, doors are weak in the area of the latch due to the drilling of the hole to accommodate the latch, making the door prone to splitting when the door is attacked with impact forces from the outside. The splitting of the door in that area often allows forced entry.

The following represents a list of known related art:

| Reference: | Issued to: | Date of Issue: |
|---|---|---|
| U.S. Pat. No. 5,647,248 | Silsby, Jr. | Jul. 15, 1997 |
| U.S. Pat. No. 6,412,145 | Rubel | Jul. 2, 2002 |
| U.S. Pat. No. 4,570,470 | Gray, Sr. | Feb. 18, 1986 |
| U.S. Pat. No. 4,342,136 | Okabe et al. | Aug. 3, 1982 |
| U.S. Pat. No. 4,226,104 | Oliver | Oct. 7, 1980 |

The teachings of each of the above-listed citations (which does not itself incorporate essential material by reference) are herein incorporated by reference. None of the above inventions and patents, taken either singularly or in combination, is seen to describe the instant invention as claimed.

### SUMMARY AND ADVANTAGES

A handle protection security device of the present invention includes a base plate having a handle hole, a tubular handle cover attached to said base plate and over said handle hole, and wherein said tubular handle cover is provided with a key hole, and a rim attached to said base plate. A security protection kit includes a handle protection security device, a strike plate, a security handle, wherein said security handle is opened by fitting a key in said handle and turning said key.

The handle protection security device and security protection kid of the present invention presents numerous advantages, including: (1) makes it very difficult for unauthorized persons to forcibly enter a protected room for the purpose of burglarizing coin-operated devices or for any other vandalism of the premises; (2) the cylindrical handle cover of the present invention prevents a burglar from breaking off the knob mechanism with a large pliers or wrench to defeat the locking function of the doorknob and latch; (3) key entry hole in the handle cover allows only something as small as a key to be applied to the lockset, preventing the forcible defeat of the lockset by prying or wedging; (4) the rim on the base plate prevents a burglar from jimmying the door at its most vulnerable point (in line with the latch) by preventing the insertion of a crowbar or prying device into the proximity of the latch; (5) the inherent strength of the 12-inch tall and ⅛″ thick strike plate together with the solidity achieved by mounting the plate to the 2×6 framework of the door with the supplied 3″-long, hardened screws, and the strength of the steel latch in a commercial lockset type handle, make it extremely unlikely that a burglar or vandal can force the door to open by the application of impact forces to the outside of the door; (6) attaching the handle protection security device to a door (through-bolts which completely surround the latch-hole) together with the inherent strength of the device itself, add a huge amount of reinforcement to the area of the door, which substantially eliminates the vulnerability of the door to splitting as a result of impact forces from outside. The handle protection security device and the security kit prevent and reduce unwanted forced entry through door. Additionally, they provide added strength and support to both the door and the doorframe, preventing breakage and loss of structural integrity.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an embodiment of a handle protection security device in use.

FIG. 2 shows an embodiment of a handle protection security device.

FIG. 3 shows the rear view of the embodiment shown in FIG. 2.

FIG. 4 shows another view of an embodiment of a handle protection security device in use with the door closed.

FIG. 5 shows a top down cross section view of an embodiment of the present invention in use with the door closed.

FIG. 6 shows an embodiment of a handle protection security device and strike plate in use with the door open.

FIG. 7 shows a top down cross section view of an embodiment of a handle protection security device and strike plate in use with the door open.

FIG. 8 shows an embodiment of strike plate.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

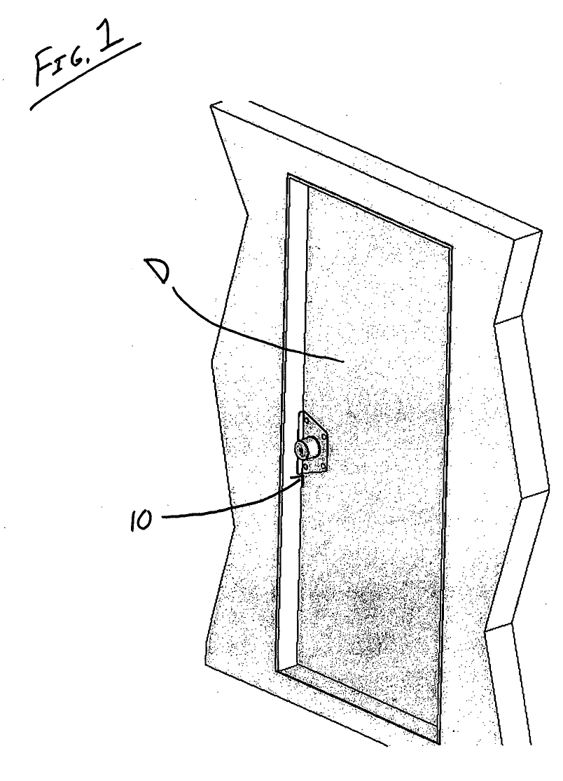

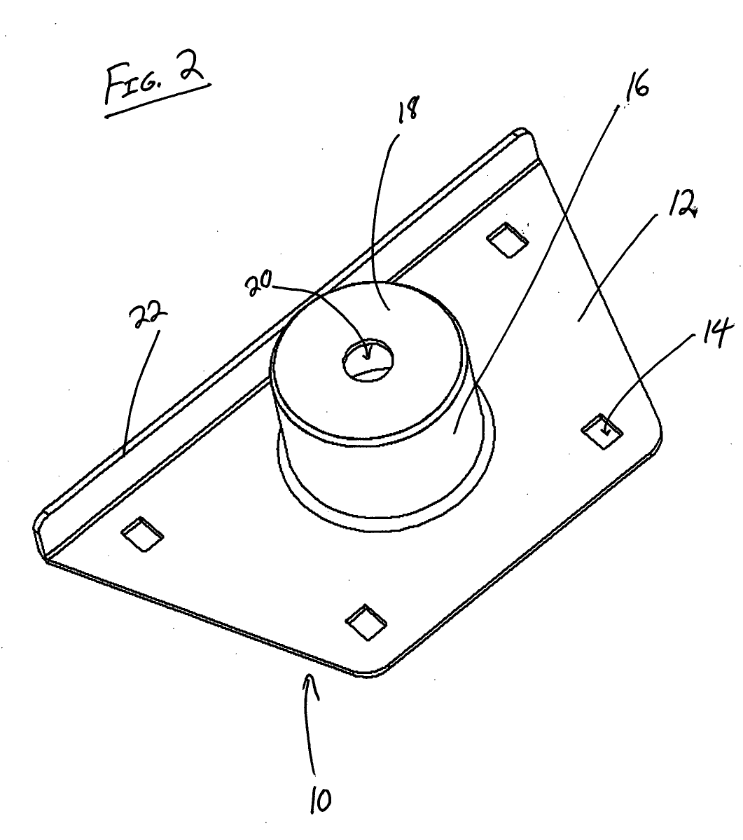

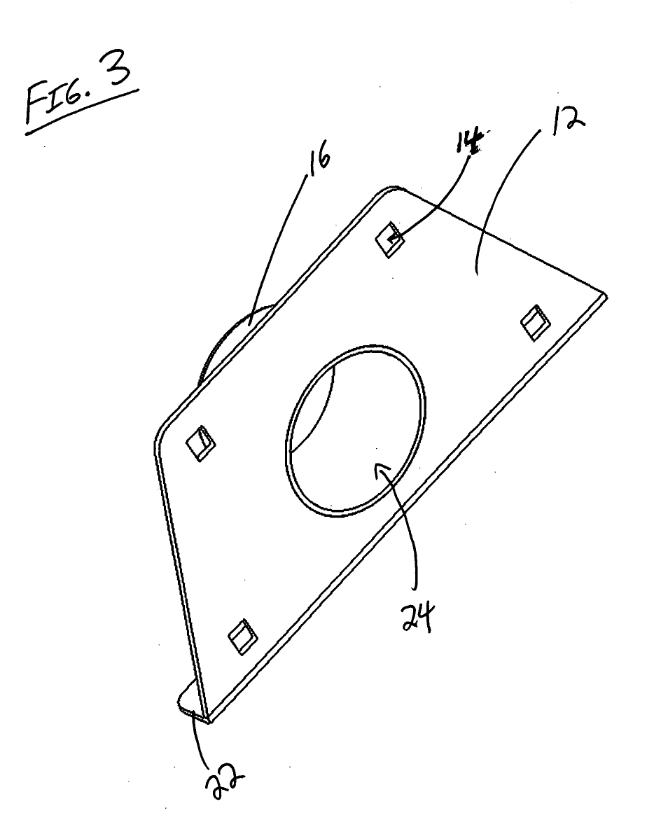

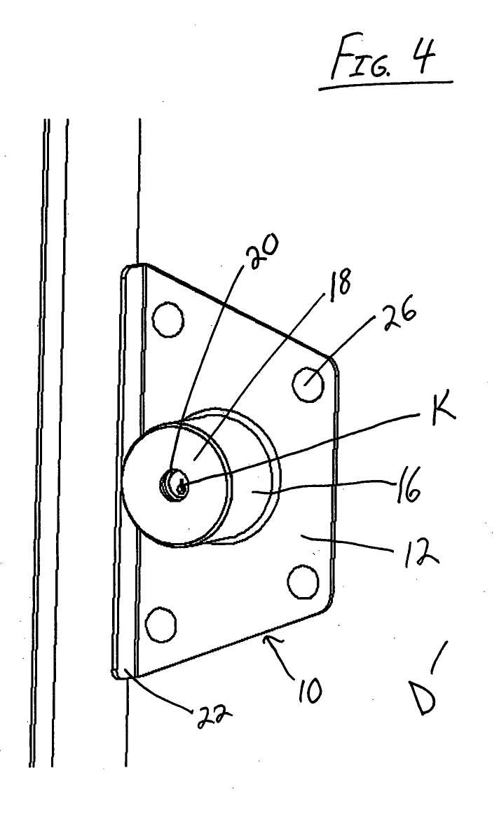

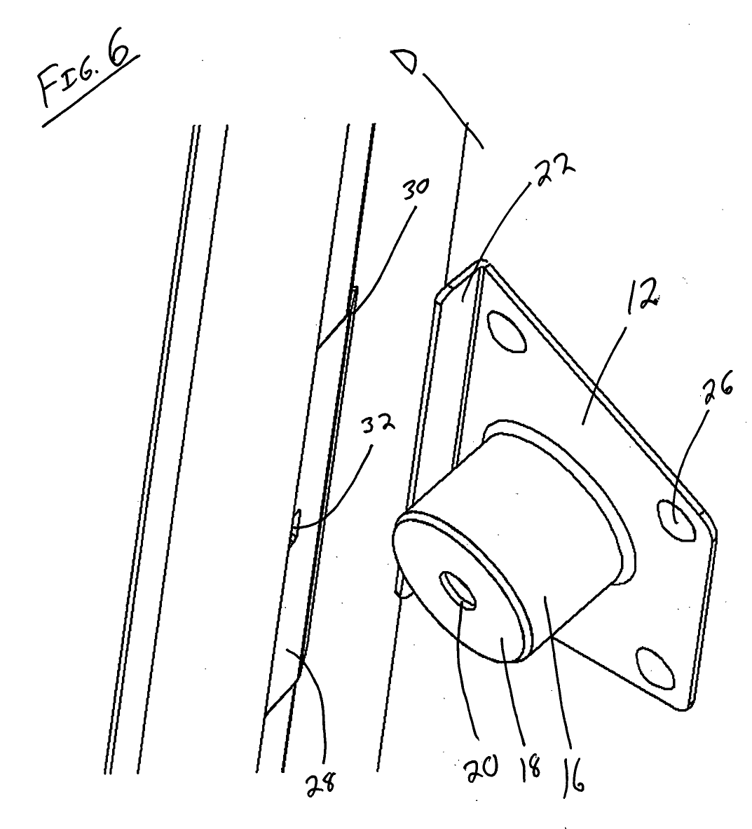

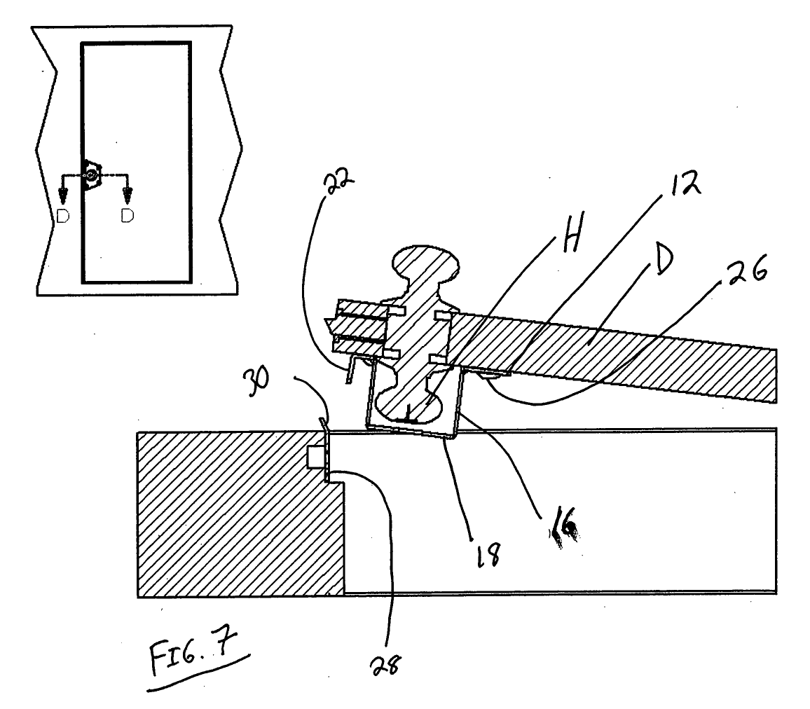

An entry protection system and apparatus is provided for attachment to door and doorframe in order to prevent unwanted admission. As shown in FIGS. 1-7, a handle protection security device 10 is provided and includes a base plate 12 having a handle hole 24, a tubular handle cover 16 attached to said base plate and over said handle hole 14, and wherein said tubular handle cover is provided with a key hole 20 in a top 18 to said cover 16, and a rim 22 attached to said base plate. A plurality of bolts, nuts, and washers is further provided to attach the device to a door D.

As shown in FIGS. 1-8, a security protection kit is provided, including a handle protection security device 10, a strike plate 28, a security handle H, wherein said security handle is opened by fitting a key in said handle and turning said key. A plurality of bolts 26, nuts, washers, and screws are further provided to attach the security device 10 and the strike plate 28 to a door D and a doorframe.

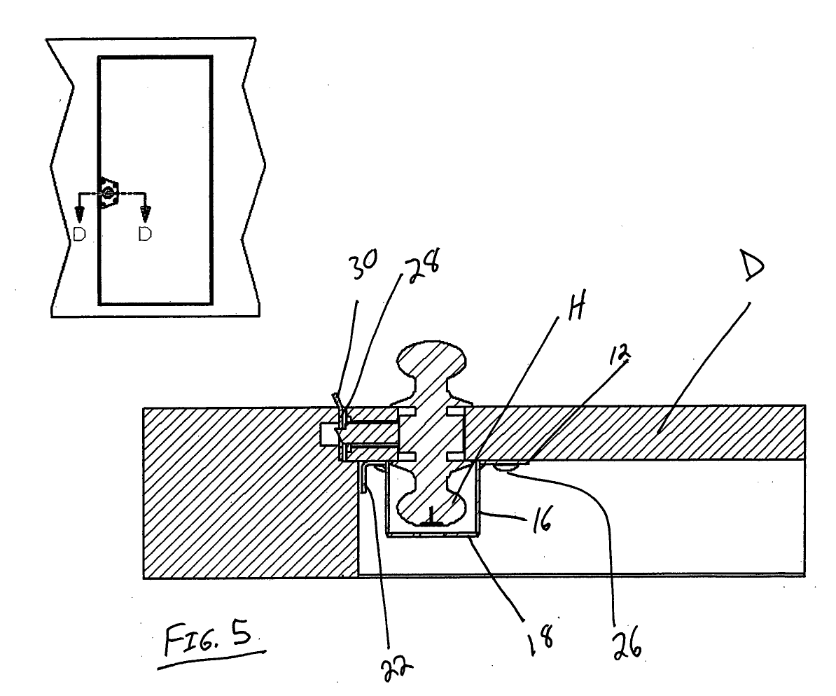

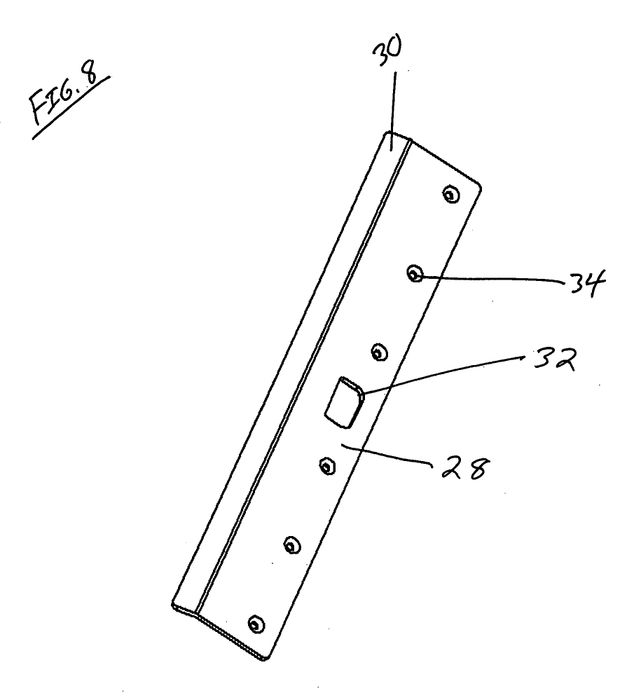

As shown in FIG. 8, the strike plate 28 is rectangular sized to fit over a standard door latch on a doorframe. The strike plate 28 is provided with a plurality of screw holes 34 for attachment to the doorframe. Preferably one long edge 30 of the strike plate inclines at an angle from the plane of the striker plate, as shown in FIGS. 5-8. The strike plate 28 is provided with a latch hole 32, preferably rectangular, sized to permit the passage of standard door latches. Strike plate 28 is longer than standard striker plates, preferably twelve inches long, to provide additional security. Screws (not shown) for attaching striker plate are longer screws, preferably three inches long or longer, to securely attach strike plate to door to provide added protection from forcible entry. Strike plate 28 is preferably ⅛ inch thick and made of 10-gage steel, but may alternatively be made with other metals of similar strength and durability.

Security handle H is preferably a security door handle where the knob of the handle does not turn, but instead the handle is turned by insertion of a key and turning the key. Such handles are commercially available and install in most doors. Such handle includes the Schlage Storeroom Lockset (F Series Orbit Entry Lockset, Schlage Lock Model: F80CSVRB626, available from Schlage Lock Company), together with a set of three properly installed spring-closure hinges, which prevent entry into a protected premises by anyone other than someone having a key which operates the lockset. The outside knob does not turn, and a key is required to withdraw the entry latch from the striker plate to allow the door to open. The spring-loaded hinges assure that the door will close and re-latch as soon as the entering or leaving person lets go of the door.

As shown in FIGS. 1-7, base plate 12 is preferably a trapezoidal guard plate with a plurality of attachment holes 14 and a larger handle hole 24 sized to allow insertion of the base plate 12 over a door handle H. Base plate 12 is provided with a rim 22 along an edge of the base plate that is preferably perpendicular to the base plate 12. Base plate 12 and rim 22 are preferably made of 10-gage steel, but may be made with other metals of similar strength and durability.

As shown in FIGS. 1-7, the tubular handle cover 16 is attached to the base plate 12 over the handle hole 24. Handle cover 16 is preferably attached by welding, but other numerous methods known to those skilled in the art may be used. The handle cover 16 is sized to completely cover a door handle H. The handle cover 16 is preferably tubular shaped, as in a cylinder with a top. The top 18 of the handle cover 16 contains a key entry hole 20 of sufficient diameter to allow a key to be inserted into the key hole K of the door handle H. The key entry hole 20 diameter is smaller than the diameter of the handle cover 16. The tubular handle cover 16 is preferably made of 10-gage steel but may be made with other metals of similar strength and durability.

In operation, the handle protection security device 10 is attached to a door D by inserting the device over a door handle H, and bolting the device through attachment holes 14 in the base plate 12 to the door D. Bolts 26 (partially shown) go through the base plate 12 and the door D, and nuts and washers attached to the bolts on the opposite side of the door secure the bolts and base plate to the door. The handle protection security device 10 is positioned such that the key entry hole 20 of the device handle cover 16 is over the key hole K of the handle H, and does not obstruct the key hole, and further positioned such that the rim 22 of the device 10 is parallel and opposite the door frame extending out from the door. A user inserts a key through the key entry hole of the device handle cover and into the keyhole of the handle, turns the handle using the key to unlock the door, and pushes the door open.

In operation, the security kit provides protection. The lengthened strike plate 28 is attached to the doorframe over the doorframe latch hole, using the long screws to secure the strike plate to the doorframe. The handle protection security device 10 is attached to the door D, as described the in preceding paragraph. The handle protection security device 10 is attached to the door D provided with a lockset type of door handle H, in which the handle does not turn, but instead the key turns the tumblers to unlock the door.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

1. A handle protection security device, comprising:
a base plate having a handle hole;
a tubular handle cover attached to said base plate and over said handle hole, and wherein said tubular handle cover is provided with a top and a key entry hole; and
a rim attached to said base plate.

2. A handle protection security device of claim 1, wherein the base plate is provided with a plurality of attachment holes, and further comprising a plurality of nuts, bolts, and washers insertable through said attachment holes to attach the base plate to a door.

3. A security protection kit, comprising:
a handle protection security device, wherein said handle protection security device includes a base plate, a tubular handle cover with a key entry hole, and a rim;
a strike plate; and
a security handle, wherein said security handle is opened by fitting a key in said handle and turning said key.

4. The kit of claim 3, wherein said strike plate is 12 inches long.

5. The kit of claims 3, further comprising a plurality of screws insertable through screw holes in said strike plate to attach said strike plate to a door frame.

6. The kit of claims 4, further comprising a plurality of screws insertable through screw holes in said strike plate to attach said strike plate to a door frame.

7. The kit of claims 5 or 6, wherein said screws are 3 inches long.

8. The kit of claim 3, wherein the strike plate is ⅛ inches thick.

9. The kit of claim 4, wherein the strike plate is ⅛ inches thick.

10. The kit of claims 8 or 9, further comprising a plurality of screws insertable through screw holes in said strike plate to attach said strike plate to a door frame.

11. A security protection kit, comprising:
a handle protection security device, wherein said handle protection security device includes a base plate, a tubular handle cover with a key entry hole, and a rim;
a strike plate, wherein said strike plate is 12 inches long and ⅛ inches thick;
a plurality of screws insertable through screw holes in said strike plate to attach said strike plate to a door frame; and
a security handle, wherein said security handle is opened by fitting a key in said handle and turning said key.
